(19) United States
(12) Patent Application Publication
(10) Pub. No.: US 2005/0187960 A1
(43) Pub. Date: Aug. 25, 2005

(54) Stream server

(75) Inventor: Yuji Nomura, Yokohama (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/116,314

(22) Filed: Apr. 28, 2005

Related U.S. Application Data
(63) Continuation of application No. PCT/JP02/11312, filed on Oct. 30, 2002.

(51) Int. Cl. G06F 17/00

(52) U.S. Cl. 707/101

(57) ABSTRACT

In a stream server distributing live data and contents through the medium of the Internet or the like by a streaming technology or the like, a contents distribution or live data distribution is performed for an indefinite number of user terminals corresponding in real time to environments respectively provided, i.e. a network load, a throughput of a user terminal, a congestion degree of the stream server or the like.

### BACKGROUND OF THE INVENTION

1. Field of the Invention

The present invention relates to a stream server, and in particular to a stream server distributing live data and contents through the medium of the Internet or the like by a streaming technology or the like.

Recently, a network such as the Internet has been broadbandized with the spread of an ADSL, a wireless LAN and the like. Together with this broadbandization, a multimedia/multichannel communication environment for transmitting/receiving data, voice, video and the like has been rapidly improved. Furthermore, a constant connection has been generalized, and an integration of home information appliances and a network has been promoted, so that the distribution of contents and live data such as video and music has been growing in demand.

In such a network, the distribution of contents and live data by a streaming technology multiplexing a multimedia to be treated as a single flow of digital information is important.

2. Description of the Related Art

FIG. 10 shows an example of a prior art live data/contents distribution system. When a user terminal (PDA) 170_2 requests the distribution of live data 720 while a cache server 150_2 does not hold the live data 720, the live data 720 photographed by a video input device 120 is provided to a real-time encoder 130.

The encoder 130 converts the live data 720 into data of a requested encoding method/encoding rate to be transmitted to the user terminal 170_2 by a live data distribution 720a through an IP network 140 and the cache server 150_2. At this time, the cache server 150_2 temporarily stores the live data 720.

When a user terminal (mobile telephone) 170_3 requests the distribution of the live data 720 of the same encoding method/encoding rate, the cache server 150_2 transmits the stored live data 720 to the user terminal 170_3 by a live data distribution 720b.

Contents 710 are stored in a source database 700 of a contents server 110. When a user terminal (desktop PC) 170_1 requests the distribution of the contents 710 while a cache server 150_1 does not store the contents 710, the contents 710 are distributed (see a contents distribution 710a) from the contents server 110 to the user terminal 170_1 through the IP network 140 and a terminal adaptor (TA) 160.

At this time, the cache server 150_1 temporarily stores the contents 710. The subsequent operation of the cache server 150_1 when the distribution of the contents 710 is requested from e.g. the user terminal 170_2 is the same as that of the cache server 150_2.

The live data distributions 720a and 720b and the contents distribution 710a are performed by an MPEG stream or the like which performs decompression processing by referring to e.g. reference data.

The IP network 140 is basically of a best-effort type, and is not adapted to the distribution of the MPEG stream without interruption for a long time.

As the conventional technologies to solve this problem, there are streaming technologies such as a Real-time Transport Protocol (hereinafter, abbreviated as RTP), a Real-time Transport Control Protocol (hereinafter, abbreviated as RTCP) and a Real-time Streaming Protocol (hereinafter, abbreviated as RTSP).

The RTP is a transmission protocol prescribing a packet form upon transmission of voice data and video data so that media synchronization may be possible on the reception side. The RTSP is a protocol for performing a stream control such as starting and pausing contents distribution. The RTCP is a protocol for prescribing a procedure of transmitting information necessary for a flow control to a voice stream and a video stream, and reference time information for the media synchronization.

By these protocols, a more pleasant RTP stream (contents distribution or live data distribution) in consideration of a provided environment such as a negotiation between a user terminal and a distribution source, a network load upon data distribution and a throughput of the user terminal is controlled in real time.

However, in the prior art streaming environment, as for the live data distribution, data of a plurality of encoding rates fixed are distributed to an indefinite number of user terminals (reception side) from a stream server (distribution side).

The user terminal, according to its own throughput, selects data from among data of fixed encoding rates from a distribution source to be received. Accordingly, a pleasant multicast contents distribution and live data distribution in real-time consideration of the network load, the throughput of the user terminal or the like are not realized for an indefinite number of user terminals respectively.

Namely, in the prior art streaming environment, it is difficult in the contents distribution to distribute certain contents (one source) in the form of data (multiuse) corresponding to each user terminal with respect to not only an encoding method but also a real-time optimum encoding rate.

In order to solve this problem, enormous hardware such as real-time encoders for the number of user terminals or a database of data for the entire encoding rate is required, which is not realistic.

Namely, it is not possible to perform “one source multiuse” with not only contents and encoding methods but also encoding rates being in the category.

Also, since the real-time encoder 130 distributes real-time encoded data as they are to the network in the live data distribution, it is difficult for the user terminal to extend a communication (selectivity) such as a reverse and a pause, to the contents server.

Accordingly, the user terminal has to receive services considering that the contents distribution is different from the live data distribution. Also, as for a distribution server, a contents server and a live server are respectively independent devices, and require to be controlled independently, so that it is difficult to integrate the contents distribution and the live data distribution.

Since a plurality of encoded data corresponding to the contents are preliminarily compiled into a database in the contents distribution, the entire contents data are required to be complied into a database regardless of movie contents watched by a numerous users or personal video contents watched by only a certain individual user, thereby requiring an enormous database capacity.

Therefore, a limit occurs in constructing a personal database storing digital contents or the like originally produced by an individual user, which is a recent trend.

Also, since the database stores compressed encoded data, and an insertion/deletion into/from an arbitrary position of a sequence header in the MPEG stream is difficult in the contents distribution, an optimum encoding rate/resolution change or the like is difficult in consideration of a random access function of an arbitrary video of the user terminal (reception side), an access line type, a network congestion degree, a user terminal throughput, or the like.

Also, since the distribution server and the cache server (edge server) are independently placed and independently operated in the prior art contents distribution or live data distribution system, the cache server can perform a hit/miss determination in consideration of contents or live data requested from the user terminal (reception side), and an encoding method.

However, it is not possible to manage a viewing start/stop/change of the requested data in consideration of even an encoding rate determined with a negotiation or a feedback of an RR (Receiver Report) type RTCP packet from the user terminal being a trigger. Accordingly, it is difficult to perform the hit/miss determination in consideration of a viewer rate.

In the prior art contents distribution or live data distribution, the stream server operates corresponding to an action from the user terminal as in the event of a negotiation operation or the RR type RTCP packet feedback in the streaming.

Accordingly, when viewing requests of an indefinite number of users mutually overlap at a date and a time when the distribution of a certain movie contents is started, numerous access conflicts to a transcoder occur, so that immediacy of the distribution service for the user terminal becomes difficult.

Also, in the prior art contents distribution or live data distribution, the cache server (edge server) stores data such as various contents or live data, encoding methods and encoding rates, and a confirmation of presence/absence of data requested by the user terminal is performed for the entire data, so that a hit/miss determination circuit requires enormous hardware scale.

Also, in the prior art contents distribution or live data distribution, the distribution server and the cache server (edge server) are independently placed and independently operated. Therefore, when new contents or live data, encoding method and encoding rate not stored in the cache server (edge server) from the user terminal are requested, it is determined to be a “miss”.

Thus, since the distribution server distributes data corresponding to the above-mentioned contents and encoding method to the cache server, the cache server has to discard the data having already been stored.

Since a congestion degree on the distribution server side is not considered in the hit/miss determination of the cache server (edge server), a throughput reduction, jitter or the like of the distributed data occur when immediacy of the distribution server is low.

Also, when an encoding rate, resolution, or the like of certain hierarchy data is changed in the prior art hierarchy encoding, encoding processing is performed by referring to an upper hierarchy as reference data.

Thereafter, since all of the upper hierarchy data are required to be regenerated, enormous hardware becomes necessary, thereby increasing the frequency of use of resources such as a transcoder, namely effective utilization of resources is difficult.

### SUMMARY OF THE INVENTION

It is accordingly an object of the present invention to realize the following items (1)-(9) in a stream server distributing live data and contents through the medium of the internet or the like by a streaming technology or the like:
(1) A contents distribution or live data distribution is performed for an indefinite number of user terminals corresponding in real time to environments respectively provided, i.e. a network load, a throughput of a user terminal, a congestion degree of the stream server or the like;
(2) An integration of the contents distribution and the live data distribution is realized with less hardware;
(3) The capacity of required database is reduced;
(4) “One source multiuse” corresponding to not only requested contents and encoding methods but also to requested encoding rates is realized;
(5) A random access of arbitrary video, and changes of an optimum encoding rate and resolution corresponding to an access line type, a network congestion degree and a user terminal throughput are made possible by the user terminal;
(6) A contents or live data distribution service corresponding to a viewing rate is performed;
(7) The speed of the determination of presence/absence of data requested by a user is enhanced;
(8) Hit errors of new contents data or new live data, the data of a new encoding method and a new encoding rate requested by a user are reduced;
(9) In a hierarchy encoding, the changes of the encoding rate and the resolution are efficiently performed.
   [Prior Art Documents]
   Japanese Patent Application Laid-open No. 2000-228669
   Japanese Patent Application Laid-open No. 2001-54095
   Japanese Patent Application Laid-open No. 2001-54094
   Japanese Patent Application Laid-open No. 10-108160
   Japanese Patent Application Laid-open No. 2000-299702

In order to achieve the above-mentioned object, a stream server of the present invention comprises: one or more transcoders; a cache database storing data; and a hit/miss determining-portion controlling, when requested contents data or live data, requested data of an encoding method and an encoding rate are not stored in the cache database, the transcoders and the cache database cooperatively so that the requested data are stored in the cache database.

Namely, transcoders, as usual, convert designated contents data or live data into data of a designated encoding method and encoding rate. A cache database stores the data.

A hit/miss determining portion controls, when requested data of an encoding method and an encoding rate are not stored in the cache database, the transcoders and the cache database cooperatively so that the requested data are stored in the cache database.

Thus, the cache database stores the contents data or live data requested by e.g. a user terminal in the form of data of the requested encoding method and the requested encoding rate, whereby each user terminal can realize a contents distribution or live data distribution of the requested encoding method and encoding rate.

It is to be noted that while the cache database and the transcoders in the above description are supposed to respectively include a control/adjusting portion described later, hereinafter the cache database will be occasionally indicated as a cache database proper and its control/adjusting portion separately, and the transcoders will be occasionally indicated as transcoders and their control/adjusting portions separately.

Also, in the present invention, the transcoders may comprise encoders or CODECs.

Namely, the transcoders in the present invention are supposed to include CODECs and encoders. In case of the live data distribution for example, the encoders can be substituted for the transcoders.

Also, in the present invention, the cache database may have a plurality of lines respectively storing the data of different encoding rates for same contents data or live data, and data of a same encoding method.

Namely, the cache database has a plurality of lines in which data converted into data of different encoding rates for e.g. the same contents data and encoding method are respectively stored.

Thus, a multicast contents distribution or live data distribution is realized for an indefinite number of user terminals. Namely, it becomes possible to realize “one source multiuse” of distributing contents or live data of an encoding method and an encoding rate corresponding to user terminals.

Also, the present invention may further comprise a call control/negotiation processor negotiating with a user terminal on a call control, or on a start control, a pause control or a reverse control of a data distribution, and notifying a result thereof to the hit/miss determining portion; and the hit/miss determining portion may control the transcoders and the cache database cooperatively based on the result.

Namely, a call control/negotiation processor negotiates with a user terminal on a call control, or on a start control, a pause control or a reverse control of a data distribution.

Based on this result, the hit/miss determining portion performs the start control, the pause control or the reverse control of the distribution of the data stored in the cache database.

Thus, it becomes possible to perform the start control, the pause control, and the reverse control for the contents distribution. Also, since the live data distribution is performed after having stored the data in the cache database, it becomes possible to perform the start control, the pause control, and the reverse control for the live data distribution.

Also, the present invention may further comprise a network monitor monitoring at least one of a network load with a user terminal, a congestion degree of a contents server and a throughput of the user terminal, and providing a monitoring result to the hit/miss determining portion; and the hit/miss determining portion may decide an optimum encoding rate based on the monitoring result.

Namely, a network monitor monitors a network load with a user terminal, a congestion degree of a contents server or a throughput of the user terminal. Based on this monitoring result, the hit/miss determining portion decides an optimum encoding rate for each user terminal.

Thus, it becomes possible to perform a contents distribution or live data distribution of an encoding rate in consideration of e.g. the network load, the congestion degree of the contents server, the current throughput of the user terminal or the like in real time.

Namely, it becomes possible to control in real time more pleasant contents distribution or live data distribution for the user under an environment provided.

Also, the present invention may further comprise a protocol mounting processor mounting a predetermined protocol and performing communication processing with a user terminal based on the predetermined protocol.

Namely, a protocol mounting processor mounts a protocol for performing communication processing between the stream server and the user terminal. Based on this mounted protocol, the contents distribution or live data distribution, and the control thereof can be performed.

Also, in the present invention, the protocol mounting processor may have at least one of an IP header processor, a UDP header processor, an RTP header processor, an RTCP header processor and an RTSP header processor.

Thus, it becomes possible to perform the contents distribution or live data distribution, and the control thereof based on protocols such as IP, UDP, RTP, RTCP and RTSP.

Also, in the present invention, the protocol mounting processor may have an MPEG sequence header processor.

Thus, changes of an optimum encoding rate and resolution of an MPEG encoding method as well as a random access function of arbitrary video or the like in consideration of an access line type, a network congestion degree, or a user terminal throughput become easy.

Also, in the present invention, the transcoders may convert at least one of material data, transcode data and live data inputted into data of the requested encoding method and of a designated encoding rate.

Namely, the transcoders receive as an input material data or transcode data from e.g. a source database device, and input live data from a video input device, thereby enabling the inputted data to be converted into the data.

It is to be noted that the connection between the stream server and the source database device or the video input device may be either a direct connection or a connection through a network.

Also, in the present invention, the hit/miss determining portion may retrieve requested contents or live data, encoding method thereof, encoding rate thereof and whether or not data are valid in a predetermined order to perform a hit/miss determination for requested data.

Namely, the hit/miss determining portion retrieves e.g. requested contents or live data, encoding method thereof, encoding rate thereof and whether or not data are valid in a predetermined order to perform a hit/miss determination for requested data.

Thus, it becomes possible to make the hit/miss determination easy and to considerably reduce hardware.

Also, in the present invention, the hit/miss determining portion may determine whether or not the encoding rate is in an allowable range in order to determine whether or not the requested contents data or live data, the requested data of the encoding method and the encoding rate are stored in the cache database.

Namely, when the hit/miss determining portion determines whether or not the requested contents data or live data, the requested data of the encoding method and the encoding rate are stored in the cache database, not only the same encoding rate as the requested encoding rate, for example, but also data of the encoding rate in an allowable range of the requested encoding rate are regarded as a hit.

Thus, it becomes possible to distribute data of the encoding rate within an allowable range instead of the requested encoding rate, and it becomes unnecessary to store the data of all of the requested encoding rates, thereby enabling an efficient operation of the cache database, and realizing a stable contents distribution and live data distribution.

Also, in the present invention, when the requested contents data or live data, the requested data of the encoding method and the encoding rate are not stored in the cache database, the hit/miss determining portion may discard the requested contents data or live data, the requested data of the encoding method and data of an encoding rate close to the requested encoding rate, and may control the transcoders and the cache database cooperatively so that the requested data are stored in a position where the discarded data have been stored.

Namely, when the requested contents data or live data, the requested data of the encoding method and the encoding rate are not stored in the cache database, the hit/miss determining portion retrieves the requested contents data or live data, the requested data of the encoding method and data of an encoding rate close to the requested encoding rate to be discarded.

The hit/miss determining portion controls the transcoders and cache database cooperatively so that the requested data are stored in the position where the discarded data have been stored.

Thus, it becomes possible to distribute the requested data to the user terminal.

Also, in the present invention, the hit/miss determining portion may discard contents data or live data for a low viewing rate, or data of encoding rate for a low viewing rate.

Thus, the size of the cache database can be reduced, and the hit ratio of the cache database is increased since the cache database keeps holding contents or live data for a high viewing rate.

Also, in the present invention, the cache database may store viewing start time information, stop time information and change time information of the requested data provided by the network monitor, and the hit/miss determining portion may perform a hit/miss determination based on the information.

Namely, the cache database stores viewing start time information, stop time information and change time information of the requested data provided by the network monitor. The hit/miss determining portion calculates e.g. a real-time viewing rate based on the information to perform a hit/miss determination based on the viewing rate.

Thus, it becomes possible for the hit/miss determining portion to perform a hit/miss determination in consideration of e.g. a real-time viewing rate.

Also, in the present invention, the hit/miss determining portion may discard at least one of contents data or live data for a low viewing rate, data of an encoding method and an encoding rate for a low viewing rate, and may instruct the transcoders and the cache database to store requested contents data or live data, the requested data of the encoding method and the encoding rate in the position where the discarded data have been stored.

Namely, in the absence of a position storing data of e.g. requested contents data or live data, data of an encoding method and an encoding rate, the hit/miss determining portion discards contents data or live data for a low viewing rate, data of an encoding method or an encoding rate for a low viewing rate.

Then, the hit/miss determining portion stores requested contents data or live data, the requested data of the encoding method and the encoding rate in the position where the discarded data have been stored.

Thus, it becomes possible to secure a position for storing the requested contents data or live data, the requested data of the encoding method and the encoding rate.

Also, it becomes possible to reduce the size of the cache database and to keep holding contents data or live data for a high viewing rate.

Thus, the hit of the cache database is increased and an efficient operation of the cache database can be realized.

Also, in the present invention, the hit/miss determining portion, when a transcoder unused exists, may control the transcoder and the cache database, and may convert new contents data or new live data into data of a predetermined encoding rate and encoding method to be stored in the cache database.

Namely, in the presence of new contents or new live data, and a transcoder unused, the hit/miss determining portion converts the new contents or new live data into data of a predetermined encoding rate and a predetermined encoding method, and controls the transcoder and the cache database so that the converted data are stored in the cache database.

Thus, when the conversion of the requested contents is not performed and there is a free space in the cache database, for example, the transcoder can preliminarily convert the new contents into data of the predetermined encoding method and the predetermined encoding rate. As a result, it becomes possible to avoid an access conflict between the transcoder and the cache database, and to realize an efficient usage of resources.

Furthermore, in the present invention, the transcoders may newly prepare only encoded data for a hierarchy whose encoding rate is changed and a next upper hierarchy in hierarchy encoding by space scalability, time scalability, or SNR scalability, and when a sum of difference absolute values of decoded data decompressed from the new upper hierarchy and decoded data decompressed from a current upper hierarchy is equal to or less than a threshold, the hierarchy whose encoding rate is changed and the next upper hierarchy may be made current hierarchies.

Thus, without exerting an influence upon the data of the encoding rate used for other data, the target encoding rate can be changed.

Also, by newly preparing only a hierarchy whose encoding rate is changed and a next upper hierarchy, it becomes unnecessary to newly prepare data in all of the upper hierarchies. Also, enormous hardware becomes unnecessary, and the frequency of use of resources such as transcoders can be reduced.

### BRIEF DESCRIPTION OF THE DRAWINGS

The above and other objects and advantages of the invention will be apparent upon consideration of the following detailed description, taken in conjunction with the accompanying drawings, in which the reference numerals refer to like parts throughout and in which:

FIG. 1 is a block diagram showing an embodiment of a stream server according to the present invention;

FIGS. 2A-2E are block diagrams showing an arrangement of a cache database in a stream server according to the present invention;

FIG. 3 is a diagram showing an example of a 3-stage retrieval procedure in a stream server according to the present invention;

FIG. 4 is a flowchart showing an operation procedure upon negotiation of a stream server according to the present invention;

FIG. 5 is a flowchart showing an operation procedure upon network monitoring of a stream server according to the present invention;

FIG. 6 is a diagram showing a hit/miss determination of a requested contents (or live data) and an encoding method or the like and subsequent processing in a stream server according to the present invention;

FIG. 7 is a diagram showing a hit/miss determination of a requested encoding rate or the like and subsequent processing in a stream server according to the present invention;

FIGS. 8A-8F are diagrams showing an example of an encoding rate change (low encoding rate →high encoding rate) in a hierarchy encoding in a stream server according to the present invention;

FIGS. 9A-9F are diagrams showing an example of an encoding rate change (high encoding→rate low encoding rate) in a hierarchy encoding in a stream server according to the present invention; and

FIG. 10 is a block diagram showing prior art contents distribution and live data distribution.

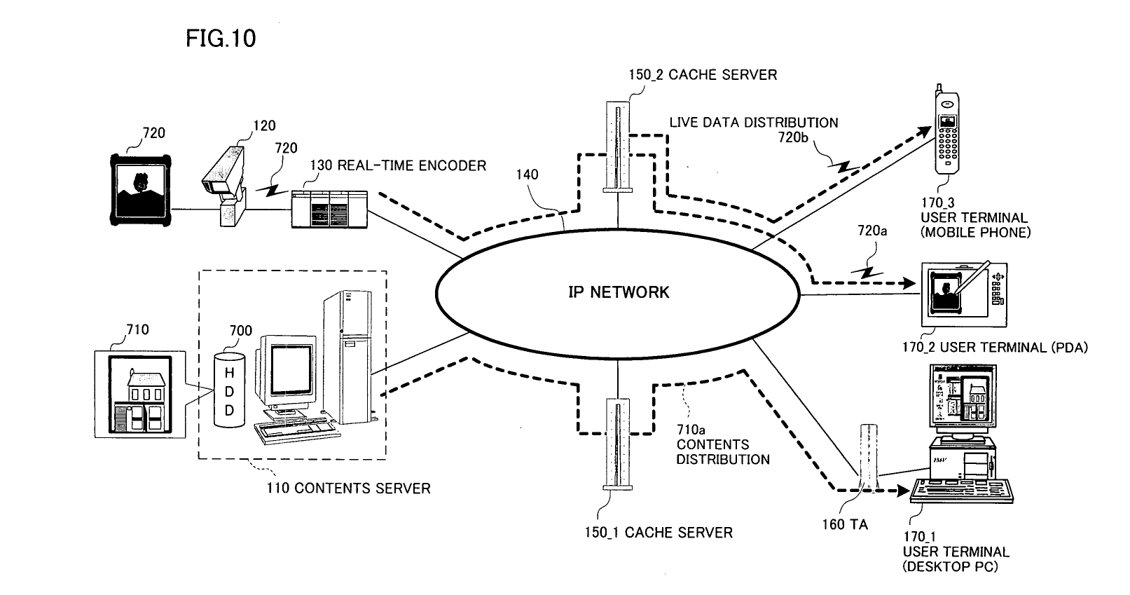

### DESCRIPTION OF THE EMBODIMENTS

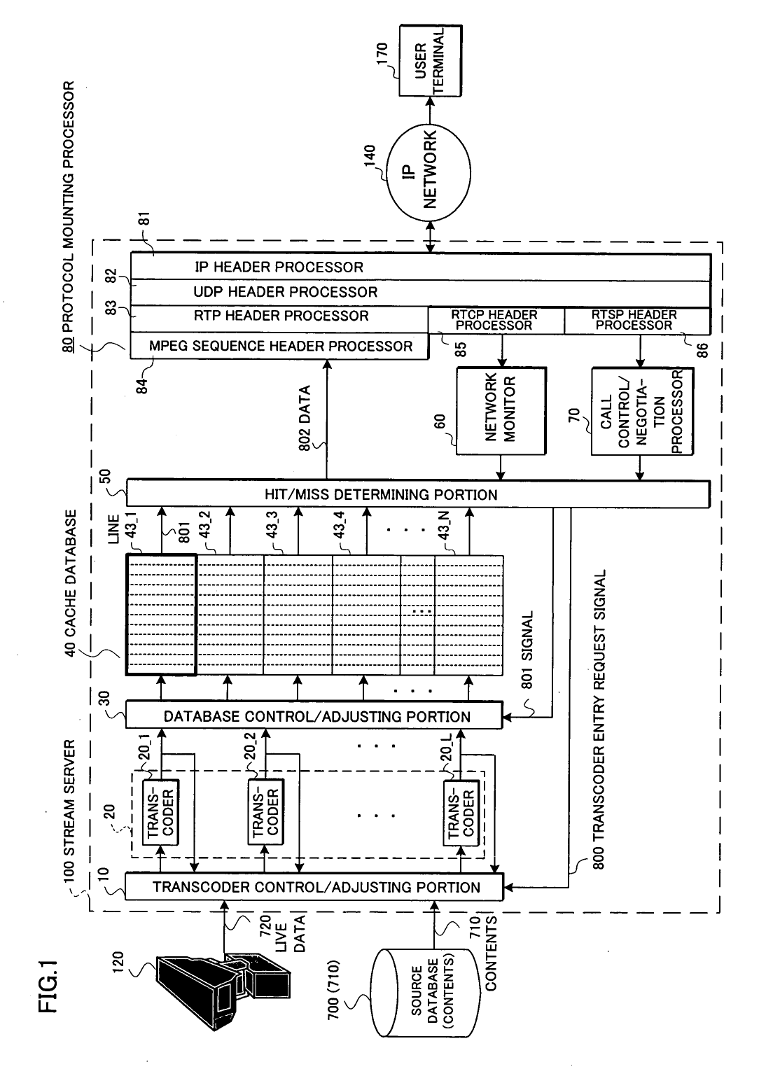

FIG. 1 shows an embodiment of a stream server 100 according to the present invention. This server 100 is composed of a transcoder control/adjusting portion 10, transcoders 20_1-20_L (hereinafter, occasionally represented by a reference numeral 20), a database control/adjusting portion 30, a cache database 40, a hit/miss determining portion 50, a network monitor 60, a call control/negotiation processor 70 and a protocol mounting processor 80.

The cache database 40 is composed of lines 43_1-43_N (hereinafter, occasionally represented by a reference numeral 43) storing contents data or live data (hereinafter, contents data and live data are occasionally represented by contents data).

The protocol mounting processor 80 is composed of an IP header processor 81, a UDP header processor 82, an RTP header processor 83, an MPEG sequence header processor 84, an RTCP header processor 85 and an RTSP header processor 86.

The hit/miss determining portion 50 confirms whether or not requested data are stored in the cache database 40. The network monitor 60 monitors the network with an RTCP protocol. The call control/negotiation processor 70 performs a call control and negotiation with the RTCP protocol.

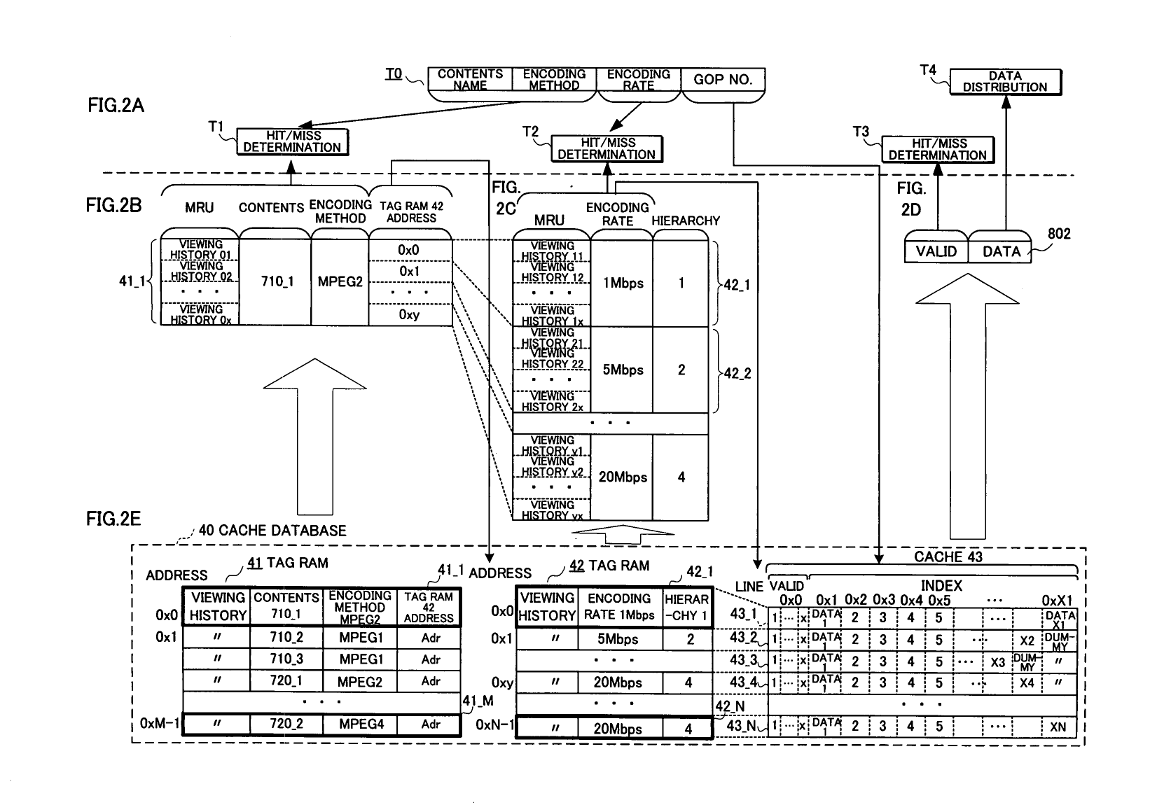

FIG. 2E shows in more detail an arrangement of the cache database 40 shown in FIG. 1. This database 40 is composed of TAG RAMs 41 and 42 and a cache 43.

The TAG RAM 41 is composed of TAG RAMs 41_1-41_M comprising fields of “MRU (Most Recently Used)”, “contents”, “encoding method” and “TAG RAM 42 address”.

The TAG RAM 41 is managed per “contents” and “encoding method”. For example, contents information and encoding method information thereof are respectively stored therein.

The “MRU” of the TAG RAM 41 stores viewing history information (e.g. viewing rate information) such as viewing start/stop/change time information when an encoding rate is changed upon negotiation or network monitoring (RR type RTCP packet feedback).

The “the TAG RAM 42 address” of the TAG RAM 41 stores a head address of the TAG RAM 42 corresponding to the “contents” and the “encoding method”.

The TAG RAM 42 is composed of TAG RAMs 42_1-42_N (hereinafter, occasionally represented by a reference numeral 42) comprising fields of “MRU”, “encoding rate” and “hierarchy”, and is managed per “encoding rate”.

The “MRU” of the TAG RAM 42 stores the viewing history information (viewing rate information) such as viewing start/stop/change time information upon changing the encoding rate.

The “encoding rate” and the “hierarchy” respectively store encoding rate information and hierarchy thereof.

The cache 43 is composed of the lines 43_1-43_N (hereinafter, occasionally represented by a reference numeral 43) respectively comprising data 1-data X1, . . . , data 1-data XN. Each line 43 further includes a valid field indicating whether each data are valid/invalid. A management unit of the contents data stored in each data 1-X1 or the like is GOP (Group Of Picture) for MPEG data.

The lines 43_1-43_N respectively correspond to the TAG RAMs 42_1-42_N, and the relationship thereof is indicated by providing fields (not shown) indicating a head address of the lines 43 to e.g. the TAG RAM 42.

FIG. 2B shows in more detail the TAG RAM 41_1 shown in FIG. 2E. This TAG RAM 41_1 indicates that the contents and the encoding method as management units are respectively “contents 710_1” and “MPEG 2”, and its MRUs are viewing histories 01-0x.

Furthermore, the TAG RAM 41_1 indicates that the head addresses of the TAG RAM 42 (encoding rate) corresponding to the “contents 710_1” and the “MPEG 2” are “0×0”, “0×1”, . . . , “0×y”.

FIG. 2C shows a more detailed example of the TAG RAMs 42_1, 42_2, . . . shown in FIG. 2E. In this example, the TAG RAM 42_1 designated by the TAG RAM 42 address=“0×0” of the TAG RAM 41_1 is indicated.

This TAG RAM 42_1 indicates that the hierarchy of the encoding rate=“1 Mbps” is “1”, and its MRUs are viewing histories 11-1x.

As a basic operation of the stream server 100, the hit/miss determining portion 50 performs a hit/miss determination of the cache database 40 respectively at the trigger [1] from a user terminal, “upon negotiation” and the trigger [2] “upon RR type RTCP packet feedback (network monitoring)”.

Also, at the trigger [3] except the trigger [1] or [2], “when a transcoder unused exists, and popular contents are newly stored in a source database, but not in the cache database 40”, the hit/miss determining portion 50 autonomously performs the hit/miss determination of the cache database 40 by a cooperative operation, and then stores the encoded data of the popular contents in the cache database 40.

Thus, when distribution requests from an indefinite number of users mutually conflict at the starting time of a popular contents distribution, for example, the popular contents can be generally read from the cache database. Thus, limited number of transcoder resources can be effectively used, and immediacy of distribution services for the user terminal (reception side) can be realized.

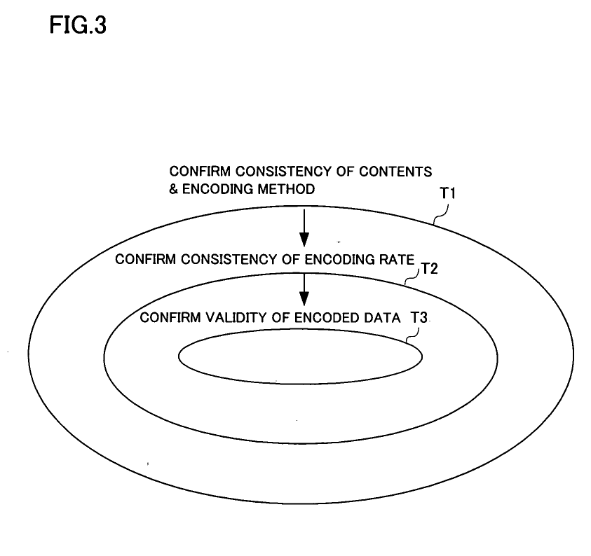

FIG. 3 shows a basic operation procedure of the hit/miss determining portion of the stream server 100. In the streaming technology, as shown in FIGS. 2A-2E, a plurality of encoding rates (1 Mbps, 5 Mbps, . . . , 20 Mbps) can be supported for e.g. the contents (or live data) 710_1 and the encoding method (MPEG 2).

The hit/miss determining portion 50 performs the hit/miss determination of the cache database 40 by the following three stages (T1)-(T3):
(T1) The hit/miss determining portion 50 retrieves the TAG RAM 41, and determines whether or not requested contents or live data and a requested encoding method are stored (see determination T1 of FIG. 2A);
(T2) The hit/miss determining portion 50 retrieves the TAG RAM 42, and determines whether or not a requested encoding rate is stored (see determination T2 of FIG. 2A);
(T3) Finally, the hit/miss determining portion 50 retrieves the “valid field” of the cache 43, and determines whether or not requested data are stored (see determination T3 of FIG. 2A).
   [I] Upon Negotiation

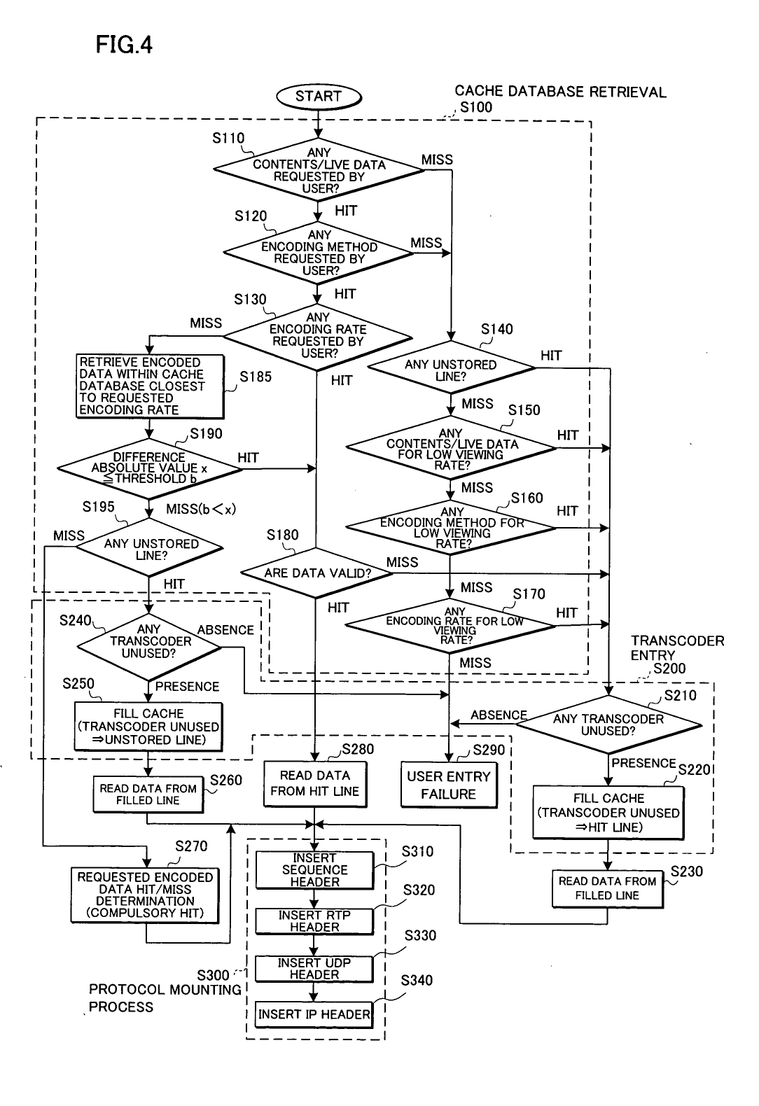

FIG. 4 shows an operation procedure example upon negotiation (trigger [1]) of the stream server 100 of the present invention. Hereinafter, this operation procedure upon negotiation will be described referring to FIG. 4 as well as FIGS. 1 and 2A-2E.

It is to be noted that in this description a case where a user terminal 170 requests contents 710 stored in a source database 700 shown in FIG. 1 will be described.

In case of the live data distribution, an encoder can be also used as the transcoder 20, which is applied to the case where the user terminal requests live data 720. Therefore, the transcoder control/adjusting portion 10 shown in FIG. 1 forms an encoder control/adjusting portion 10.

In FIG. 4, step S100 enclosed by dashed lines indicates a cache database retrieval procedure of the hit/miss determining portion 50. Step S200 enclosed by dashed lines indicates a transcoder entry procedure in the transcoder control/adjusting portion 10, the database control/adjusting portion 30, and the hit/miss determining portion 50. Step S300 enclosed by dashed lines indicates a procedure of a protocol mounting process in the protocol mounting processor 80.

In FIG. 1, the call control/negotiation processor 70 establishes a connection between the stream server 100 and the user terminal 170 by a call control/negotiation operation from the user terminal 170.

Steps S110-S130: The hit/miss determining portion 50 confirms whether or not the contents data, encoding method and encoding rate requested by the user terminal 170, e.g. data coincident with contents 710_1, MPEG 2 and 5 Mbps are stored in the cache database 40.

Namely, in FIGS. 2A-2E, the hit/miss determining portion 50 receives e.g. a request of a contents name=contents 710_1, an encoding method=“MPEG 2” and an encoding rate=“5 Mbps”, (T0) in FIG. 2A, from the user terminal 170.

It is to be noted that there is no request of a GOP No. shown in FIG. 2A upon negotiation.

The hit/miss determining portion 50 in FIG. 2B performs the hit/miss determination T1 shown in FIG. 2A of retrieving the contents 710_1 and the encoding method=“MPEG 2” from the TAG RAM 41 to hit the TAG RAM 41_1.

Furthermore, the hit/miss determining portion 50 performs the hit/miss determination T2 shown in FIG. 2A of retrieving an encoding rate=“5 Mbps” from the TAG RAMs 42_1-42_y respectively corresponding to the head addresses=0×0, 0×1, . . . , 0×y given in the TAG RAM 42 address field of the TAG RAM 41_1.

Step S180: Furthermore, the hit/miss determining portion 50 performs the hit/miss determination T3 (see FIG. 2D) of determining whether or not the data of the line 43_2 corresponding to the hit TAG RAM 42_2 are valid.

When data are invalid, the hit/miss determining portion 50 proceeds to step S210 of the transcoder entry.

Step S280: When the encoded data are valid, the hit/miss determining portion 50 reads the valid data “1” as data 802 to be provided to the protocol mounting processor 80. By repeating this operation, data 1-data X2 of the line 43_2 are sequentially provided to the protocol mounting processor 80.

Steps S310-S340: After inserting an MPEG sequence header, an RTP header, a UDP header and an IP header into data 801, the protocol mounting processor 80 starts the distribution of the contents stored in the line 43_2 to the user terminal 170 through the IP network 140 (data distribution T4 of FIG. 2A).

Steps S140-S170: In case of a “miss” (when there are no data) at steps S110 and S120, the hit/miss determining portion 50 retrieves a data unstored line 43, or contents for a lower viewing rate than a preset threshold “a”, an encoding method and an encoding rate for a low viewing rate from the cache database 40.

Namely, in FIG. 2E, the hit/miss determining portion 50 retrieves the data unstored line 43. When there are no data (“miss”), the hit/miss determining portion 50 retrieves the contents/encoding method indicating the lower viewing rate than the threshold “a” in the MRUs of the TAG RAM 41. When there are no data (“miss”), the hit/miss determining portion 50 retrieves an encoding rate indicating the lower viewing rate than the threshold “a” in the MRUs of the TAG RAM 42.

Step S210: In the presence of a single hit (a hit line exists) in the above-mentioned retrievals, the hit/miss determining portion 50 provides a transcoder entry request signal 800 and a signal 801 respectively to the transcoder control/adjusting portion 10 and the database control/adjusting portion 30.

When e.g. the transcoder 20_2 is unused, the transcoder control/adjusting portion 10 provides the contents (material or transcode) 710 requested by the user and indicated by the transcoder entry request signal 800 to the transcoder 20_2 from the source database 700.

In the absence of a transcoder unused, the process proceeds to step S290.

Step S220: The transcoder 20_2 provides data which are contents 710 having a real-time encoding process performed thereto, to the database control/adjusting portion 30. The database control/adjusting portion 30 stores the encoded data or fills cache in e.g. an unstored line (or low viewing rate line) 43_1 within the cache database 40.

Step S230: The hit/miss determining portion 50 reads the data 802 from the cache-filled line 43_2 to be provided to the protocol mounting processor 80.

Steps S310-S340: The protocol mounting processor 80, in the same way as the above-mentioned steps S310-S340, sequentially starts the contents distribution or live data distribution requested by the user terminal 170 through the IP network 140.

Step S290: When all of the retrievals of the unstored line, contents, encoding method and encoding rate for a low viewing rate are “miss” at the above steps S140-S170, or when there is no transcoder 20 unused (transcoder entry request failure) at step S210, the entry request from the user terminal 170 fails.

[2] Upon Network Monitoring

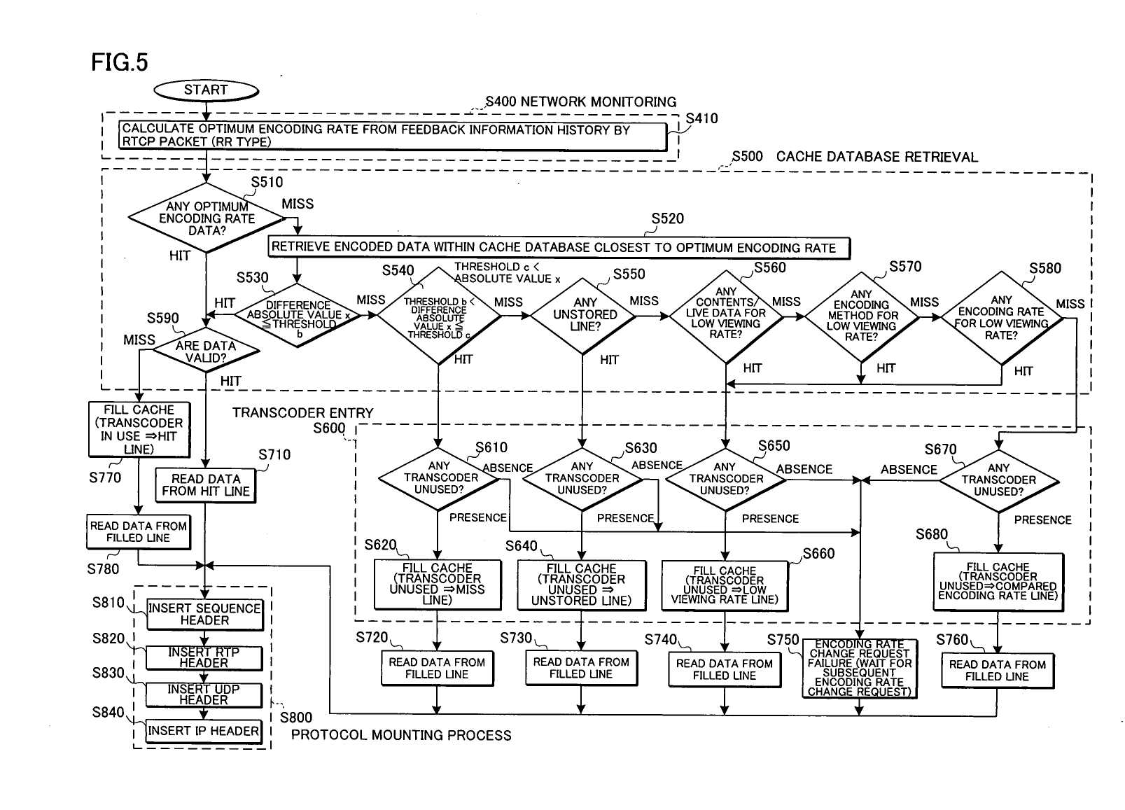

FIG. 5 shows an operation procedure upon receiving the RR type RTCP packet from the user terminal 170 (see FIG. 1) when the stream server 100 performs the contents distribution or live data distribution for the user terminal 170.

This operation procedure will now be described referring to FIGS. 2A-2E. In FIG. 5, step S400 indicates a procedure of the network monitoring, step S500 indicates a retrieval procedure from the cache database, step S600 indicates an entry procedure to the transcoder and step S800 indicates a procedure of the protocol mounting process.

Step S410: The call control/negotiation processor 70 receives the RR type RTCP packet transmitted from the user terminal 170, and provides feedback information included in the packet to the hit/miss determining portion 50.

The RR type RTCP packet is for feeding back information concerning a reception state (Fraction Lost, Cumulative Number of Packet Lost, Interarrival Jitter) of the stream to the stream transmission side by the user terminal having received the stream.

Based on the information, the hit/miss determining portion 50 calculates an optimum encoding rate in consideration of the present network congestion degree, the throughput of the user terminal 170 and the like, from the number of viewers, the viewing history, the fraction lost, the cumulative number of packet lost, the interarrival jitter and the like.

Namely, the hit/miss determining portion 50 decides T0 of FIG. 2A, i.e. a name of contents distributed, an encoding method, an encoding rate and a GOP No. for the user terminal 170. Step S510: The hit/miss determining portion 50 confirms whether or not the data coincident with the calculated optimum encoding rate are stored in the cache database 40.

Namely, the hit/miss determining portion 50 performs the hit/miss determinations T1 and T2, in FIGS. 2B and 2C, for determining whether or not an optimum encoding rate for the requested contents and encoding method exists.

Steps S590 and S710: When the optimum encoding rate exists (hit), the hit/miss determining portion 50 performs the hit/miss determination T3 for determining whether or not data of the line corresponding to the encoding rate are valid (see FIG. 2A).

When the data are hit (valid), the hit/miss determining portion 50 provides the data 802 read from the hit line 43 to the protocol mounting processor 80.

Steps S810-S840: The protocol mounting processor 80 sequentially distributes the optimum encoding rate data 802 into which the MPEG sequence header, the RTP header, the UDP header and the IP header are inserted to the user terminal 170 through the IP network 140. Thus, the data 802 of the optimum encoding rate are distributed to the user terminal 170 subsequent to the previous encoding rate data.

Steps S590 and S770: The case of data miss (invalid) indicates the state where the requested encoding rate exists in the cache, but the target data themselves do not exist.

Therefore, the hit/miss determining portion 50 provides the signals 800 and 801 respectively to the transcoder control/adjusting portion 10 and the database control/adjusting portion 30.

Based on the signals 800 and 801, the transcoder in use encodes the requested contents into data of the requested encoding rate by the requested encoding method, so that the data are stored (cache-filled) in the line 43 hit at step S510.

Step S780: The hit/miss determining portion 50 reads the data of the hit line 43 to be provided to the protocol mounting processor 80.

Steps S810-S840: The protocol mounting processor 80 sequentially distributes the data 802 into which the MPEG sequence header, the RTP header, the UDP header and the IP header are inserted to the user terminal 170 through the IP network 140.

Thus, the data of the optimum encoding rate are distributed to the user terminal 170.

Steps S510 and S520: When the data of the optimum encoding rate do not exist (miss), the hit/miss determining portion 50 retrieves encoded data closest to the optimum encoding rate from the cache database 40.

Namely, the hit/miss determining portion 50, in FIGS. 2B and 2C, retrieves the closest encoding rate (compared encoding rate) to the optimum encoding rate from the encoding rates of the TAG RAM 42 corresponding to the TAG RAM 41 corresponding to the requested contents and encoding method.

Step S530: In case of a difference absolute value “x”=|optimum encoding rate−compared encoding rate | being equal to or less than a preset threshold “b”, the hit/miss determining portion 50 regards that the requested data are present.

Step S590: The hit/miss determining portion 50 performs the hit/miss determination T3 of determining whether or not data of a line regarded as hit are valid. If they are valid, the hit/miss determining portion 50 reads the data to be provided to the protocol mounting processor 80.

Namely, the hit/miss determining portion 50, in FIGS. 2C and 2D, provides the valid data 802 read from the line 43 corresponding to the TAG RAM 42 of the encoding rate hit to the protocol mounting processor 80. The subsequent operation hereafter is the same as above steps S810-S840.

Thus, the data 802 which are not data of the optimum encoding rate but within an allowable range are distributed to the user terminal 170.

Step S540: When the difference absolute value “x” is more than the set threshold “b” and equal to or less than a threshold “c”, the hit/miss determining portion 50 provides the transcoder entry request signal 800 to the transcoder control/adjusting portion 10 since the requested data do not exist (miss determination in hit/miss determinations T1 and T2 in FIG. 2A) and data of the compared encoding rate stored in the cache database 40 are unnecessary (change request of an encoding rate by the RR type RTCP packet exists).

Steps S610 and S620: When the transcoder 20 unused exists within the transcoders 20 for the transcoder entry request, the transcoder control/adjusting portion 10 performs real-time encoding process with material data or transcode data as a source, and stores processed data (fills cache) in a compared encoding rate line (miss line) within the cache database 40.

Step S720: The hit/miss determining portion 50 provides the data 802 read from the cache-filled line to the protocol mounting processor 80.

Steps S810-S840: The protocol mounting processor 80 sequentially distributes the data 801 to the user terminal 170 through the IP network 140.

Thus, it becomes possible to fill the data of the optimum encoding rate in the line of the compared encoding rate whose difference (absolute value) with the optimum encoding rate is more than the threshold “b” and equal to or less than the threshold “c”. By the filled data, influence to the video and the voice for the user terminal using the data of the line of the compared encoding rate is little.

When the difference (absolute value) is more than the set threshold “c”, and an encoding rate change from the compared data to the request data is performed, influence to the video and the voice for the user using the data of the compared encoding rate is large.

Therefore, the hit/miss determining portion 50 performs the following determination.

Steps S550 and S630: Since the difference (absolute value) of the compared encoding rate is large, the hit/miss determining portion 50 retrieves the unstored line 43 from the cache database 40, and provides the transcoder entry request signal 800 to the transcoder control/adjusting portion 10 when the target line exists (hit).

Steps S640 and S730: When a transcoder 20 unused exists for the transcoder entry request, the transcoder control/adjusting portion 10 provides the material data or the transcode data to the transcoder 20 unused.

The transcoder 20 performs the real-time encoding process to the provided data, and stores the data or fills cache in the unstored line 43 through the database control/adjusting portion 30. The data 802 are read from this filled line to be transmitted to the user terminal.

Steps S560-S580: Since there is no unstored line, the hit/miss determining portion 50 retrieves from the cache database 40 the line 43 with the contents, the encoding method or the encoding rate of the lower viewing rate than the preset threshold value “a”, and requests the transcoder entry from the transcoder control/adjusting portion 10 when target data exist (hit).

Steps S650 and S660: When the transcoder 20 unused exists for the transcoder entry request, the transcoder control/adjusting portion 10 provides the material data or the transcode data to the transcoder 20 unused.

The transcoder 20 performs the real-time encoding process to the provided data to be stored (cache-filled) in the low viewing rate line 43 within the cache database 40 through the database control/adjusting portion 30.

Step S740: The hit/miss determining portion 50 reads the data 802 from the cache-filled line 43 to be provided to the protocol mounting processor.

Steps S810-S840: The protocol mounting processor 80 sequentially distributes the data into which the above-mentioned headers are inserted to the user terminal.

Steps S580, S670, S680 and S760: When the target data do not exist in the retrieval of the unstored line and the viewing history line lower than the threshold “a” stored in the above-mentioned cache database, the hit/miss determining portion 50 provides the transcoder entry request signal 800 to the transcoder control/adjusting portion 10.

When the transcoder unused exists, the real-time encoding process is performed to the material data or the transcode data to be stored (cache-filled) in the compared encoding rate line 43 within the cache database 40. The data read from the cache-filled line 43 are provided to the protocol mounting processor 80.

Steps S810-S840: The protocol mounting processor 80 continues sequent data distributions to the user terminal 170.

Steps S610, S630, S650, S670 and S750: When no transcoder 20 unused exists, an encoding rate change request based on the RR type RTCP packet fails.

The hit/miss determining portion 50 continues the transmission of the data of the current encoding rate and waits for the subsequent encoding rate change request.

By such a cooperative operation of the transcoder control/adjusting portion 10, the transcoder 20, the database control/adjusting portion 30, the cache database 40 and the hit/miss determining portion 50, the stream server 100 can perform a real-time encoding process in consideration of the real-time network load, the throughput of the user terminal and the like not only in the live data distribution but also in the contents distribution.

Also, the stream server 100 discards the contents data and the live data of the encoding rate and encoding method for a low viewing rate, thereby keeping only the contents data and live data of an encoding rate and an encoding method for a high viewing rate stored in the cache database 40.

As a result, high viewing rate data stored in the cache database 40 can be normally distributed to the numerous user terminals.

Namely, the stream server 100 can realize a pleasant multicast distribution of contents and live data in consideration of the real-time network load, the throughput of the user terminal 170, a congestion degree of the stream server 100 and the like to an indefinite number of users respectively, thereby enabling “one source multiuse” to be realized with not only contents and encoding methods but also encoding rates being in the category.

Also, since the stream server 100 can usually read (hit) contents distribution data and live distribution data for an indefinite number of users from the cache database storing the contents data and the live data of the encoding rate and the encoding method for a high viewing rate, it becomes unnecessary to prepare the user number of transcoders, thereby enabling the number of transcoders to be greatly reduced.

Also, since the cache database 40 of the stream server 100 always discards the contents and the live data for a low viewing rate watched only by an individual user, and keeps on holding only the contents and the live data for a high viewing rate such as movie contents watched by numerous users, the size of the database can be greatly reduced, so that the distribution service of a personal database can be easily performed in the stream server 100.

Also, the stream server 100 places the cache the database 40 at the subsequent stage of the transcoder 20, and distributes the contents data and the live data to the user after the data are once stored in the cache database 40. Therefore, it is possible in the live data distribution to extend communication functions (selectivity) such as a reverse request and a pause request for the stream server (distribution side) from the user terminal (reception side).

Namely, the user terminal (reception side) 170 can enjoy services without distinguishing the live data distribution from the contents distribution, and can integrate the live data distribution and the contents distribution.

Also, the stream server 100 inserts the MPEG sequence header processor 84 at the subsequent stage of the cache database 40, whereby it becomes easy to change the frame rate, the resolution and the like mounted in the sequence header, and the change of the optimum encoding rate/resolution and the like can be easily realized in consideration of a random access function of an arbitrary video of the user terminal (reception side), an access line type, a congestion degree of the network, the throughput of the user terminal and the like.

Thus, the stream server 100 of the present invention can realize, by the cooperative operation of the transcoder 20 and cache database 40, “one source multiuse” by the pleasant multicast communication for an indefinite number of user terminals 170 and an integration of the live data distribution and the contents distribution by community environment construction between the user terminal 170 and the stream server 100. Also, the stream server (distribution side) can realize a real-time and optimum control in an environment provided so that the user (reception side) can enjoy a more pleasant distribution service. Moreover, a greater reduction of the hardware is made possible.

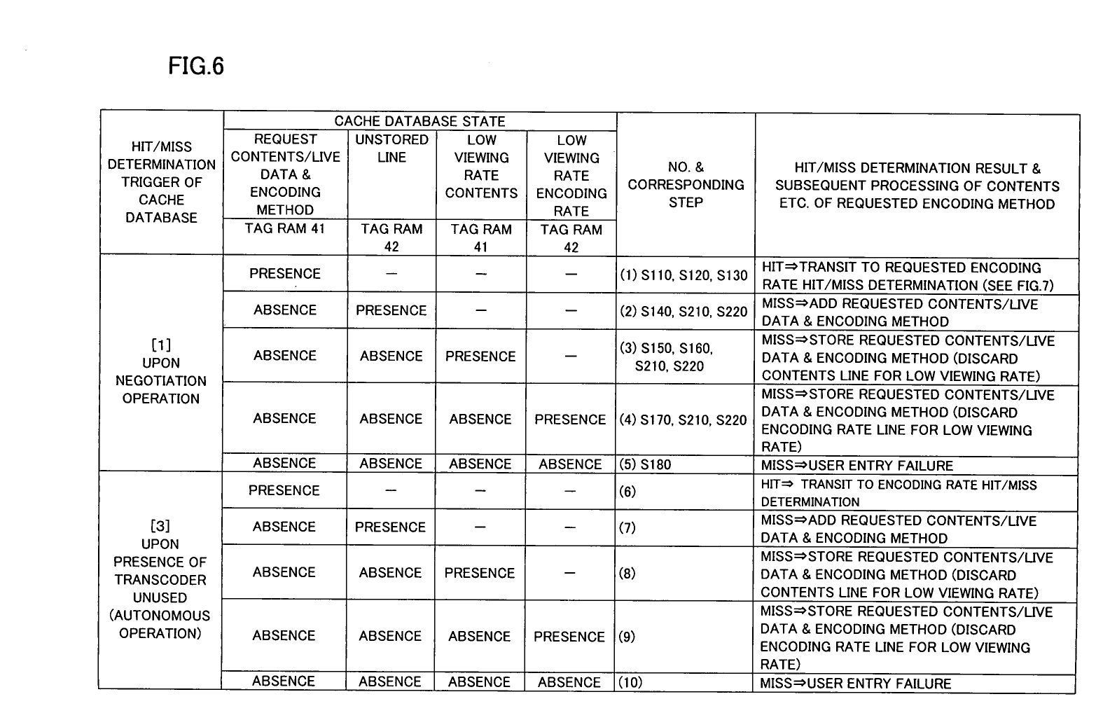

FIG. 6 shows in more detail a hit/miss determination method of the requested contents (or live data), encoding method and the like in the hit/miss determining portion 50 of the stream server 100 according to the present invention. It is to be noted that the reference numerals of steps shown in FIG. 6 correspond to those of FIG. 4.

[1] Hereinafter, hit/miss determinations (1)-(5) based on a three-stage retrieval flow of the cache database 40 upon negotiation will be described.

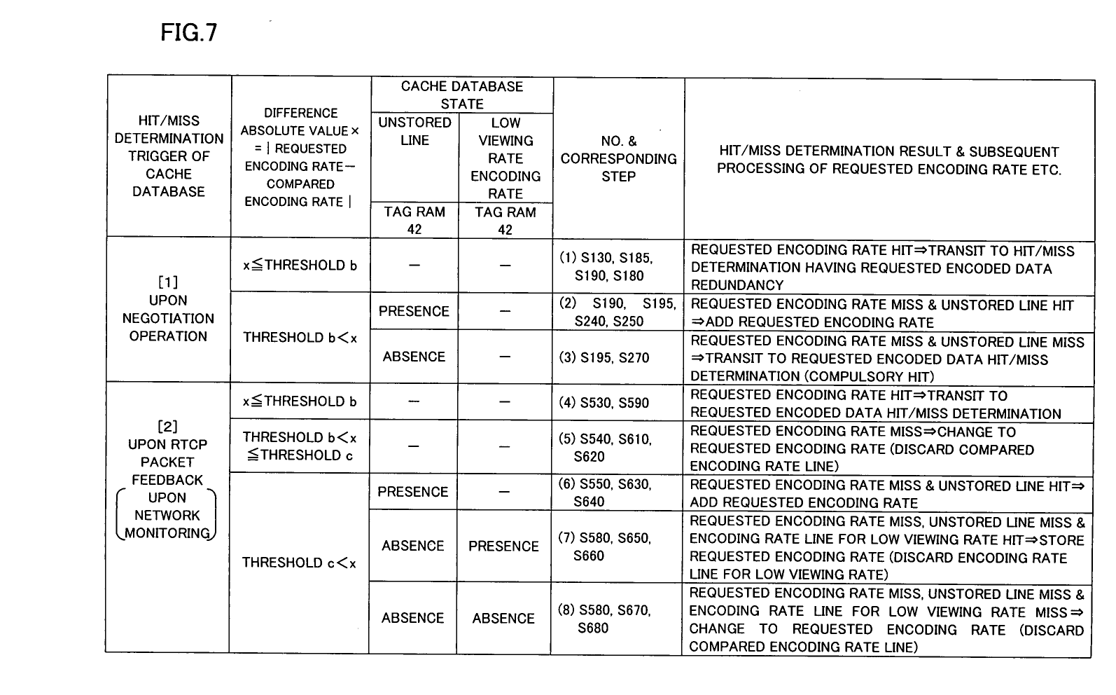

(1) The hit/miss determining portion 50 retrieves the TAG RAM 41 to perform the hit/miss determination T1 of the requested contents (or live data) and encoding method. When the requested data exist (hit), the hit/miss determining portion 50 transits to the hit/miss determination T2 of the requested encoding rate of FIG. 7 which will be described later (see steps S110-S130 in FIG. 4).

(2) When the requested data do not exist (miss) in the TAG RAM 41, the hit/miss determining portion 50 retrieves an unstored line 43 of the TAG RAM 42 to store the requested data in the unstored line 43 (see steps S140, S210 and S220 in FIG. 4).

(3) When no unstored line exists (miss) upon the retrieval of the TAG RAM 42, the hit/miss determining portion 50 retrieves a contents line for a low viewing rate. When the target data exist (hit), the data of the contents line for the low viewing rate are discarded and the requested data are stored in that line (see steps S150, S160, S210 and S220).

(4) When no contents line for the low viewing rate exists (miss) upon the retrieval of the TAG RAM 41, the hit/miss determining portion 50 retrieves the encoding rate line for the low viewing rate from the MRUs of the TAG RAM 42. When the target data exist (hit), the data of the encoding rate line for the low viewing rate are discarded and the requested data are stored in that line (steps S170, S210 and S220).

(5) When neither the contents for the low viewing rate nor the encoding rate for the low viewing rate exists upon the retrieval of the TAG RAMs 41 and 42, the hit/miss determining portion 50 fails in reading of the target data (see step S180).

[3] Hereinafter, hit/miss determinations (6)-(10) by an autonomous operation of the cache database 40 in the presence of the transcoder unused will be described. By this autonomous operation, popular contents newly stored in the source database are automatically stored in the cache database. The operations of the determinations (6)-(10) are respectively the same as above-mentioned (1)-(5).

(6) When the contents (or live data) of the requested (new) encoding method exist (hit), the hit/miss determining portion 50 transits to the hit/miss determination T2 of the encoding rate of FIG. 7 which will be described later.

(7) When the contents (or live data) of the requested encoding method do not exist (miss) and an unstored line exists, the contents (or live data) of the requested encoding method are added to the unstored line.

(8) When neither the contents (or live data) of the requested encoding method nor the unstored line exist (miss), and contents for the low viewing rate exist, the contents for the low viewing rate are discarded, and the contents (or live data) of the requested encoding method are added to the contents line for the low viewing rate having the contents discarded therefrom.

(9) When none of the contents (or live data) of the requested encoding method, the unstored line and the contents for the low viewing rate exist (miss) while the encoding rate for the low viewing rate exists, the encoding rate for the low viewing rate is discarded, and contents (or live data) of requested encoding method are added to the encoding rate line for the low viewing rate having the encoding rate discarded therefrom.

(10) When none of the contents (or live data) of the requested encoding method, the unstored line, the contents for the low viewing rate, and the encoding rate for the low viewing rate exist (miss), the entry of the new contents fails.

By the determinations (7)-(9), the new contents are autonomously stored in the cache database.

FIG. 7 shows an example of the hit/miss determination T2 of the requested encoding rate in the present invention.

This determination has a redundancy. Namely, the determination depends on the magnitude relationship between the difference absolute value “x” (absolute value “x” of the difference between the encoding rate of compared encoded data stored in the cache database 40 currently distributed and encoding rate of the requested data) and predetermined thresholds “b” and “c”.

Also, the determination operation upon negotiation differs from the determination operation upon network monitoring (RR type RTCP packet feedback). It is to be noted that reference numerals of the steps shown in FIG. 7 correspond to those in FIGS. 4 and 5.

[1] Hereinafter, hit/miss determinations (1)-(5) of the requested encoding rate or the like upon negotiation will be described.

(1) In case the difference absolute value “x”≦ the threshold “b”, the hit/miss determining portion 50 determines that the requested encoding rate exists (hit), and transits to the hit/miss determination T3 having redundancy in requested encoded data.

(2) In case the threshold “b”<the difference absolute value “x”, the hit/miss determining portion 50 determines that the requested encoding rate does not exist (miss), and when an unstored line is retrieved from the MRUs of the TAG RAM 42 and there is an unstored line, the hit/miss determining portion 50 stores the requested data in the unstored line.

(3) When the unstored line does not exist (miss) in the above-mentioned unstored line retrieval, the hit/miss determining portion 50 determines that the hit/miss determination of the requested encoding rate is compulsorily hit, and transits to the hit/miss determination T3 of the subsequent requested encoded data.

[3] Hereinafter, the hit/miss determination T2 (4)-(8) of the requested encoding rate upon network monitoring (RR type RTCP packet feedback) will be described.

(4) In case the difference absolute value “x”≦ the threshold “b”, the hit/miss determining portion 50 determines that the requested encoding rate exists (supposition hit), and transits to the hit/miss determination T3 of the requested encoded data.

(5) In case the threshold “b”<the difference absolute value “x”≦ the threshold “c”, the hit/miss determining portion 50 determines that the requested encoding rate does not exist (miss), discards the data of the compared encoding rate line and then stores the requested data in this line.

(6) In case the threshold “c”<the difference absolute value “x”, the hit/miss determining portion 50 determines that the requested encoding rate does not exist (miss). When an unstored line is retrieved from the MRUs of the TAG RAM 42 and the unstored line exists and target data exist (hit), the hit/miss determining portion 50 stores the requested data in the unstored line.

(7) When an unstored line does not exist (miss) in the above-mentioned unstored line retrieval, and the encoding rate line for the low viewing rate exists (hit) in the TAG RAM 42, the hit/miss determining portion 50 stores the requested data in the encoding rate line for the low viewing rate.

(8) When neither the above-mentioned unstored line nor the encoding rate line for the low viewing rate exists (miss), the hit/miss determining portion 50 discards the line of the compared encoding rate, and stores the requested data in this line.

It is to be noted that the above-mentioned determinations (5)-(8) are processings in the presence of a transcoder to be used.

Also, since the real-time encoding rate control is performed by the encoding RTCP packet (RR type) feedback, an autonomous encoding rate control (hit/miss determination T2 of the requested encoding rate) in the presence of the transcoder unused is basically unnecessary.

In case of the transition to the hit/miss determination T3 of the above-mentioned requested encoded data, the hit/miss determining portion 50 performs the hit/miss determination T3 in the retrieval from the cache 43. When the requested data exist (hit), the hit/miss determining portion 50 determines to be a “hit”. When the requested data does not exist (miss), the requested data are stored in the target index.

As mentioned above, by queuing viewing start/stop/change time information for each user per contents, encoding method and encoding rate respectively in the MRUs of the TAG RAMs 41 and 42 as shown in FIGS. 2A-2E in the cache database 40, the hit/miss determination in consideration of the viewing start/stop time and a real-time viewing rate for each user for the data stored in the cache database can be performed.

Also, the above-mentioned hit/miss determination of the cache database 40 is performed at the following triggers: normal determination trigger [1], upon negotiation by the distribution request from a certain user terminal (reception side); normal determination trigger [2], upon RR type RTCP packet feedback. Furthermore, the hit/miss determination is performed at the operation trigger [3] in the presence of the transcoder unused, in addition to the determination triggers [1] and [2]. Thus, popular contents newly stored in the source database, and unstored in the cache database can be preliminarily stored (cache-filled).

Also, in the streaming technology, a plurality of encoding rates for certain contents or live data, and an encoding method are supported.

Accordingly, the hit/miss determination of the cache database 40 performs a three-stage retrieval such as a retrieval of the data corresponding to the requested contents or live data, and encoding method for the distribution request from the user (hit/miss determination T1), a subsequent retrieval of the data corresponding to the requested encoding rate (hit/miss determination T2), and a final retrieval of the requested data(hit/miss determination T3). Thus, the determination can be simplified/speeded up, and a great reduction of a hardware scale of a hit/miss determination circuit can be realized.

Also, in the hit/miss determination of the cache database 40, when none of the requested contents or live data, encoding method, encoding rate and encoded data from the user (reception side) exist (miss), the viewing history stored in the MRUs of the TAG RAMs 41 and 42 is referred to, and the contents and encoding rate line for the low viewing rate are discarded. Therefore, only the contents for the high viewing rate requested by an indefinite number of users and the data of the encoding rate for the high viewing rate are stored, thereby realizing an efficient cache operation.

Also, in the hit/miss determination of the cache database, when the difference absolute value with the encoding rate currently used for the optimum requested encoding rate in consideration of the network congestion degree and the throughput of the user terminal based on the RR type RTCP packet feedback information is equal to or less than a predetermined threshold, the hit/miss determination with redundancy is performed, whereby a rapid change of the real-time network congestion degree and the throughput of the user terminal are not followed.

Also, even if the absolute value is equal to or more than the predetermined threshold, when data stored in the cache database are entirely data for e.g. the high viewing rate, for example, no influence is exerted upon distribution data to other users by performing a compulsory hit determination.

By the above-mentioned operation, the stream server of the present invention can realize distribution request data of its own and distribution data to other user terminals by the autonomous operation.

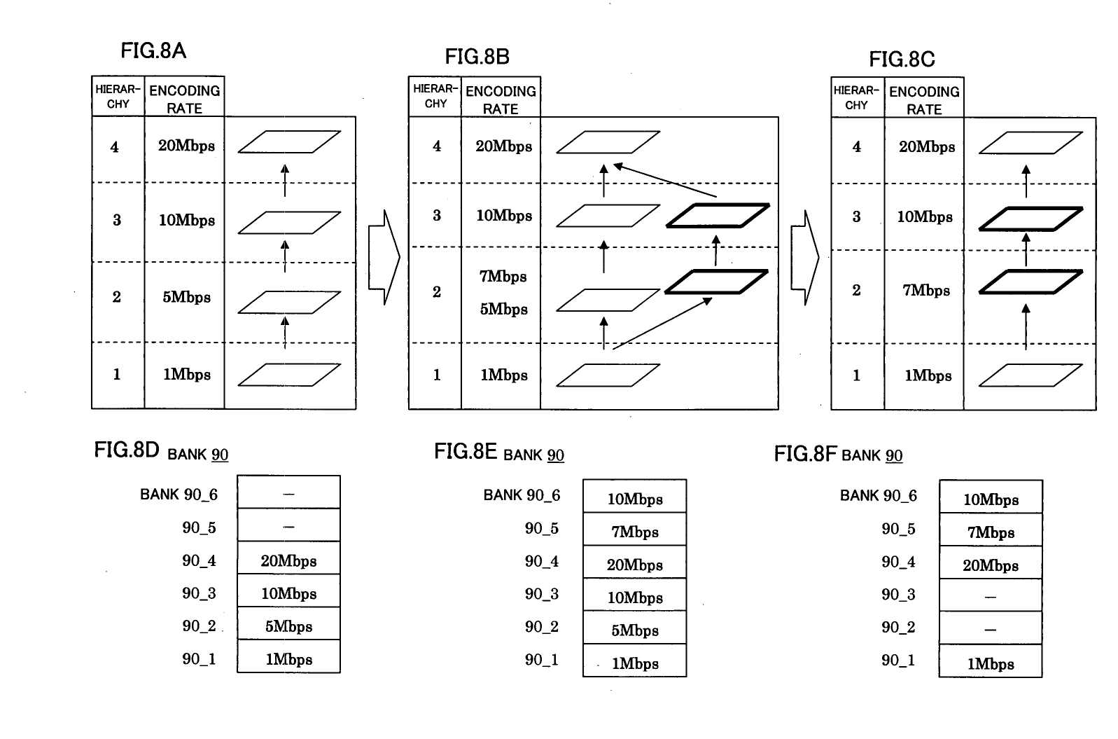

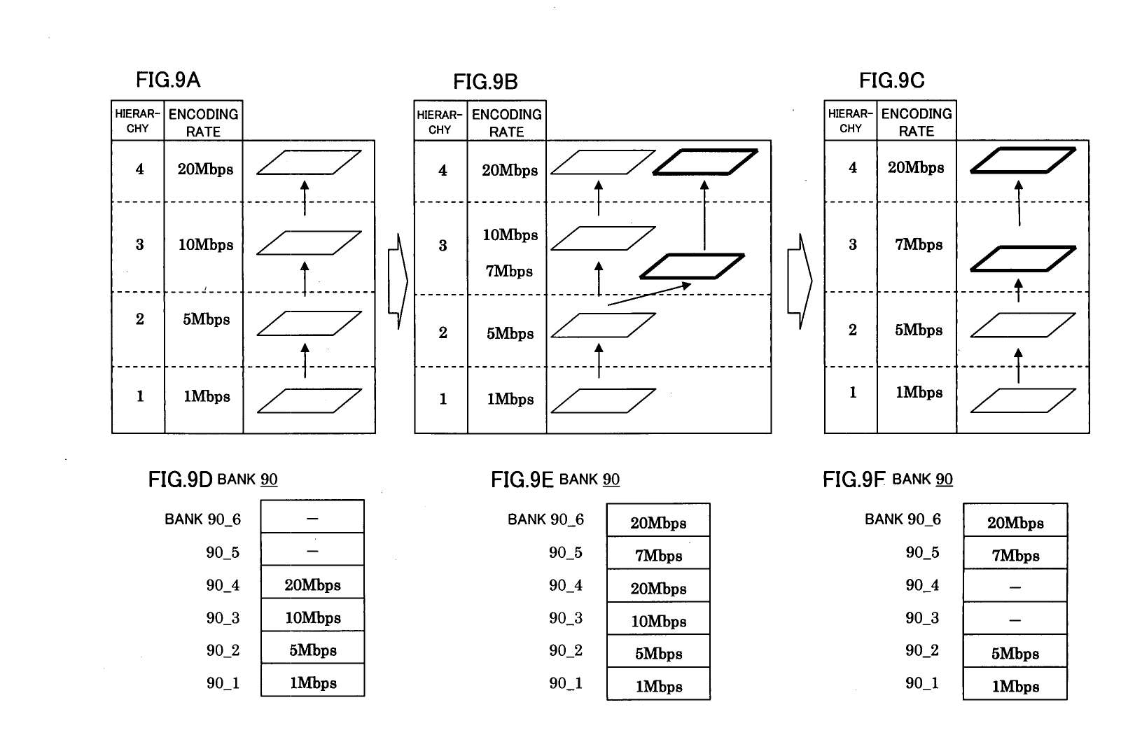

FIGS. 8A-8F and FIGS. 9A-9F show examples of a hierarchy encoding method in the stream server 100 of the present invention. This hierarchy encoding is hierarchized by space scalability, time scalability, SNR (Signal to Noise Ratio) scalability or the like. When the encoding rate of a certain hierarchy is changed, new encoded data are prepared only for encoded data for a hierarchy whose encoding rate is changed and for a next upper hierarchy.

FIGS. 8A-8F show a case where the low encoding rate is changed to the high encoding rate. In FIG. 8A, encoding rates of the hierarchies of 1, 2, 3 and 4 are 1 Mbps, 5 Mbps, 10 Mbps and 20 Mbps, respectively.

FIG. 8D shows a bank 90 where the encoding rates of the hierarchies 14-4 shown in FIG. 8A are stored. In banks 90_1-90_4, the data whose encoding rates are 1 Mbps, 5 Mbps, 10 Mbps and 20 Mbps are respectively stored.

When the encoding rate of the hierarchy 2 is changed from 5 Mbps (low encoding rate) to 7 Mbps (high encoding rate) in FIGS. 8B and 8E, new encoded data of new hierarchy 2 and new encoded data of new hierarchy 3 (10 Mbps) to which decompression operation is performed referring to the new hierarchy 2 are respectively stored in the banks 90_5 and 90_6.

When the sum of the difference absolute values of the decoded frame data decompressed from the new hierarchy 3 and the decoded frame data decompressed from the current hierarchy 3 is equal to or less than a certain threshold in FIGS. 8C and 8F, the current hierarchies 2 and 3 (banks 90_2 and 90_3) are discarded and new hierarchies 2 and 3 (banks 90_5 and 90_6) are made the current hierarchies 2 and 3, so that a hierarchy arrangement is switched to a new one.

FIGS. 9A-9F show a case where the high encoding rate is changed to the low encoding rate. FIGS. 9A and 9D are respectively the same as FIGS. 8A and 8D.

When the encoding rate of the hierarchy 3 is changed from 10 Mbps (high encoding rate) to 7 Mbps (low encoding rate) in FIGS. 9B and 9E, new encoded data of a new hierarchy 3 (7 Mbps) and a new hierarchy 4 (20 Mbps) performing a decompression operation referring to the new hierarchy 3 are stored in the banks 90_5 and 90_6.

When the sum of the reference absolute values of the decoded frame data decompressed from the new hierarchy 4 and the decoded frame data decompressed from the current hierarchy 4 is equal to or less than a certain threshold in FIGS. 9C and 9F, the current hierarchies 3 and 4 (banks 90_3 and 90_4) are discarded and the new hierarchies 3 and 4 (banks 90_5 and 90_6) are made the current hierarchies 2 and 3, so that a hierarchy arrangement is switched to a new one.

Namely, in the above-mentioned hierarchy encoding, when an encoding rate of a certain hierarchy is changed, only the next upper hierarchy data, not all of the data in the following upper hierarchies using the hierarchy data as reference data, are changed, thereby enabling a new hierarchy arrangement to be structured by changing the encoding rate.

In the encoding rate change, the number of banks required is only a number of hierarchies +2, so that the reduction of the hardware scale is made possible.

As described above, the stream server of the present invention is arranged such that a hit/miss determining portion controls, when requested contents data or live data, requested data of an encoding method and an encoding rate are not stored in the cache database, the transcoders and the cache database cooperatively so that the requested data may be stored in the cache database. Therefore, a contents distribution is performed for an indefinite number of user terminals corresponding in real time to environments respectively provided, i.e. a network load, a throughput of a user terminal, a congestion degree of the stream server and the like. Also, an integration of the contents distribution and the live data distribution can be realized by reduced hardware.

1. A stream server comprising:
one or more transcoders;
a cache database storing data; and
a hit/miss determining portion controlling, when requested contents data or live data, requested data of an encoding method and an encoding rate are not stored in the cache database, the transcoders and the cache database cooperatively so that the requested data are stored in the cache database.

2. The stream server as claimed in claim 1, wherein the transcoders comprise encoders or CODECs.

3. The stream server as claimed in claim 1, wherein the cache database has a plurality of lines respectively storing the data of different encoding rates for same contents data or live data, and data of a same encoding method.

4. The stream server as claimed in claim 1, further comprising a call control/negotiation processor negotiating with a user terminal on a call control, or on a start control, a pause control or a reverse control of a data distribution, and notifying a result thereof to the hit/miss determining portion;
the hit/miss determining portion controlling the transcoders and the cache database cooperatively based on the result.

5. The stream server as claimed in claim 1, further comprising a network monitor monitoring at least one of a network load with a user terminal, a congestion degree of a contents server and a throughput of the user terminal, and providing a monitoring result to the hit/miss determining portion;
the hit/miss determining portion deciding an optimum encoding rate based on the monitoring result.

6. The stream server as claimed in claim 1, further comprising a protocol mounting processor mounting a predetermined protocol and performing communication processing with a user terminal based on the predetermined protocol.

7. The stream server as claimed in claim 6, wherein the protocol mounting processor has at least one of an IP header processor, a UDP header processor, an RTP header processor, an RTCP header processor and an RTSP header processor.

8. The stream server as claimed in claim 6, wherein the protocol mounting processor has an MPEG sequence header processor.

9. The stream server as claimed in claim 1, wherein the transcoders convert at least one of material data, transcode data and live data inputted into data of the requested encoding method and of a designated encoding rate.

10. The stream server as claimed in claim 1, wherein the hit/miss determining portion retrieves requested contents or live data, encoding method thereof, encoding rate thereof and whether or not data are valid in a predetermined order to perform a hit/miss determination for requested data.

11. The stream server as claimed in claim 1, wherein the hit/miss determining portion determines whether or not the encoding rate is in an allowable range in order to determine whether or not the requested contents data or live data, the requested data of the encoding method and the encoding rate are stored in the cache database.

12. The stream server as claimed in claim 1, wherein when the requested contents data or live data, the requested data of the encoding method and the encoding rate are not stored in the cache database, the hit/miss determining portion discards the requested contents data or live data, the requested data of the encoding method and data of an encoding rate close to the requested encoding rate, and controls the transcoders and the cache database cooperatively so that the requested data are stored in a position where the discarded data have been stored.

13. The stream server as claimed in claim 1, wherein the hit/miss determining portion discards contents data or live data for a low viewing rate, or data of encoding rate for a low viewing rate.

14. The stream server as claimed in claim 5, wherein the cache database stores viewing start time information, stop time information and change time information of the requested data provided by the network monitor, and the hit/miss determining portion performs a hit/miss determination based on the information.

15. The stream server as claimed in claim 1, wherein the hit/miss determining portion discards at least one of contents data or live data for a low viewing rate, data of an encoding method and an encoding rate for a low viewing rate, and instructs the transcoders and the cache database to store requested contents data or live data, the requested data of the encoding method and the encoding rate in a position where the discarded data have been stored.

16. The stream server as claimed in claim 1, wherein the hit/miss determining portion, when a transcoder unused exists, controls the transcoder and the cache database, and converts new contents data or new live data into data of a predetermined encoding rate and encoding method to be stored in the cache database.

17. The stream server as claimed in claim 1, wherein the transcoders newly prepare only encoded data for a hierarchy whose encoding rate is changed and a next upper hierarchy in hierarchy encoding by space scalability, time scalability, or SNR scalability, and when a sum of difference absolute values of decoded data decompressed from the new upper hierarchy and decoded data decompressed from a current upper hierarchy is equal to or less than a threshold, the hierarchy whose encoding rate is changed and the next upper hierarchy are made current hierarchies.
